(19) United States
(12) Patent Application Publication
(10) Pub. No.: US 2005/0201426 A1
(43) Pub. Date: Sep. 15, 2005

(54) Laser

(76) Inventors: Jean-Charles Joseph Camille Cotteverte, Montreal (CA); Jevgenij Kosenko, Montreal (CA); Roman Rus, St-Leonard (CA)

Correspondence Address: Madan, Mossman & Sriram, P.C.;Suite 700, 2603 Augusta, Houston, TX, 77057, US

(21) Appl. No.: 11/079,736

(22) Filed: Mar. 14, 2005

(30) Foreign Application Priority Data
Mar. 12, 2004 (GB) GB 0405553.9

(51) Int. Cl. H01S 3/10

(52) U.S. Cl. 372/20

(57) ABSTRACT

A method of stabilising a laser in order to maintain the laser in SLM operation is disclosed. The laser comprises a resonator cavity comprising an output coupler 2, a laser rod 1 and rear mirror 3. A first beam reflected by an intra-cavity etalon 4 is reflected by a polariser 8 and passes through a quarter-wave plate 13 to a polarisation beam splitter 10. The first beam is detected by a first detector Dₓ. A portion of a second beam transmitted by the intra-cavity etalon 4 is also reflected by the polariser 8 and similarly passes through the quarter-wave plate 13 to the polarisation beam splitter 10. The second beam is detected by a second detector D_{y} A difference between the intensity of the two beams detected by the first and second detectors Dₓ, D_{y} is determined. The difference signal is fedback to a piezo-electric transducer 9. The piezo-electric transducer 9 is coupled to the rear mirror 3 of the laser and varies the optical length of the resonator cavity in response to the difference signal.

### CROSS-REFERENCE TO RELATED APPLICATIONS

This application relates to and claims priority from U.K. application GB 0405553.9 for “A LASER”, filed on Mar. 12, 2004, the entire contents of which are hereby incorporated herein by reference.

### BACKGROUND OF THE INVENTION

1. Field of the Invention

The present invention relates to a laser and a method of stabilizing a laser. The preferred embodiment relates to a method of stabilising the energy of a pulsed SLM solid-state laser having an intra-cavity etalon.

2. Description of the Related Art

For certain holographic applications it is desirable to be able to use a red, green and blue (RGB) laser to write holographic pixels of a colour hologram. In order to ensure a good interference between the object and reference beams which are used to write the holographic pixels, the coherence length between the two beams should preferably be longer than the path difference of the two beams. As a result, in order to have a suitably long coherence length, it is highly desirable that the laser used in such applications should operate in a single longitudinal mode (SLM). In order to ensure that the laser operates in a SLM an etalon may be provided within the resonator cavity.

As will be understood by those skilled in the art, over time ambient temperature changes will effectively alter the optical length of the laser or resonator cavity even though the laser or resonator cavity may be mounted on super-invar bars. Typically, the drift due to changes in the air temperature is approximately 300 MHz/°C. and the drift to changes in the laser cooling water temperature is approximately 600 MHz/°C. The Free Spectral Range (“FSR”) of a laser is typically approximately 180 MHz and hence as will be understood by those skilled in the art and as will be made apparent in the following description, the laser only needs to drift by approximately half of the FSR (i.e. approximately 90 MHz) for the laser to change from operating in SLM to operating in a dual lasing mode. This represents a temperature change of only approximately 0.1 °C. The output of the laser will therefore begin to drift in frequency over a period of time. In particular, the relative laser frequency will begin to vary with respect to the resonance frequency of the etalon.

FIGS. 1A and 1B show the typical pulse energy and the transmission of an etalon as the frequency drifts. It will be understood by those skilled in the art that because of the intrinsic transmission of the etalon (Airy function with peaks at resonances) the laser losses will also vary with respect to the laser frequency relative to the etalon resonance frequency. The laser may not therefore always be in SLM which can be particularly disadvantageous especially in certain applications such as holography. The simultaneous oscillation of two longitudinal modes will therefore occur when these two modes undergo substantially the same losses.

FIG. 2A shows a mode of operation wherein one longitudinal mode is clearly less lossy than other modes and hence the laser will operate in SLM. FIG. 2B shows the situation when two longitudinal modes experience substantially the same losses. In this situation, both laser modes will oscillate substantially simultaneously and hence the laser will no longer operate in the desired SLM mode of operation. The optical length of the laser is equal to qλ/2, wherein q is the longitudinal index of the operating mode.

In order to keep the laser operating in a SLM the laser needs to be stabilised. However, measuring the absolute value of the laser frequency in order to stabilise the laser is largely impractical for various reasons.

It is known to introduce a defect or a marker into the energy profile of a laser in order to assist in stabilising the laser. For example, in inhomogeneously-broadened gas lasers the Lamp dip may be used as a marker of the line center if it is deep enough. If not, then the gain curve itself may be used.

It is also known to introduce a saturable absorber inside a laser cavity and to use it as a reference. The saturable absorber is resonant at the operating wavelength. The defect in the profile is then a peak whose bandwidth is normally narrower (i.e. more accurate for modulation) than the Lamb dip.

However, it is generally disadvantageous to have to introduce a defect or marker into the energy profile of a laser, especially a solid state laser. Moreover, the broadening in a solid state laser is homogeneous.

It is therefore desired to stabilise the energy of a laser, especially a solid state laser, without needing to introduce a defect or marker and without, for example, having to provide a special cell including a saturable absorber.

### SUMMARY OF THE INVENTION

According to an aspect of the present invention there is provided a laser comprising:
a laser or resonator cavity;
one or more etalons located within the laser or resonator cavity;
a first detector for detecting at least a portion of a first beam reflected from the one or more etalons, the first detector outputting a first signal;
a second detector for detecting at least a portion of a second beam transmitted by the one or more etalons, the second detector outputting a second signal;
means for determining a difference between the first and second signals; and
one or more devices for translating, varying or altering the optical length of the laser or resonator cavity in response to a control signal based upon the difference between the first and second signals.

The laser preferably further comprises a polarisation beam splitter for separating at least a portion of the first beam from at least a portion of the second beam. The polarisation beam splitter is preferably arranged outside of the laser or resonator cavity.

A polariser is preferably arranged within the laser or resonator cavity. At least a portion of the first beam and/or at least a portion of the second beam is preferably directed or reflected out of the laser or resonator cavity by the polariser.

A quarter-wave plate is preferably arranged outside of the laser or resonator cavity and arranged between the polariser and a polarisation beam splitter.

A quarter-wave plate is preferably arranged within the laser or resonator cavity and arranged between the one or more etalons and a polariser.

The one or more etalons are preferably arranged to select or encourage the laser to operate in a single longitudinal mode.

The laser or resonator cavity preferably comprises a linear laser or resonator cavity. However, according to a less preferred embodiment the laser or resonator cavity may comprise a ring laser or resonator cavity.

The laser preferably comprises at least one output coupler. The at least one of the devices for translating, varying or altering the optical length of the laser or resonator cavity is preferably arranged to translate, vary or alter the at least one output coupler.

A quarter-wave plate is preferably arranged between the one or more etalons and the at least one output coupler.

The laser preferably comprises at least one rear mirror. The at least one of the devices for translating, varying or altering the optical length of the laser or resonator cavity is preferably arranged to translate, vary or alter the at least one rear mirror.

A quarter-wave plate is preferably arranged between the one or more etalons and the at least one rear mirror.

The one or more devices for translating, varying or altering the optical length of the laser or resonator cavity preferably comprises one or more piezo-electric transducers or devices or one or more piezo-ceramic transducers or devices.

The means for determining a difference preferably comprises an operational amplifier. The laser preferably further comprises a low-pass filter for low-pass filtering a difference signal or averaging means for averaging a difference signal, the difference signal being based upon the difference between the first and second signals.

The difference signal after being low-pass filtered or averaged is preferably arranged to be applied or supplied, in use, to the one or more devices in order to translate, vary or alter the optical length of the laser or resonator cavity.

The laser preferably comprises one or more active or laser rods or active media arranged within the laser or resonator cavity.

One or more active or laser rods or active media are preferably arranged on the same side of a polariser as the one or more etalons. Alternatively, the one or more active or laser rods or active media may be arranged on the opposite side of a polariser as the one or more etalons.

A first additional quarter-wave plate may be provided between the polariser and the one or more active or laser rods or active media.

A second additional quarter-wave plate may be provided between the one or more active or laser rods or active media and an output coupler or rear mirror.

The laser preferably comprises a Q-switch arranged within the laser or resonator cavity.

The laser preferably comprises a pulsed laser. Less preferably, the laser may comprise a continuous wave laser.

The laser preferably comprises a solid-state laser. According to a less preferred embodiment the laser may comprise a gas or liquid laser.

According to the preferred embodiment the laser is operated, in use, in a single longitudinal mode.

According to an aspect of the present invention there is provided a holographic printer for printing holograms comprising a laser as described above.

The holographic printer is preferably a red, green and blue (“RGB”) holographic printer. The holographic printer preferably comprises a Master Write or Direct Write holographic printer.

According to an aspect of the present invention there is provided a method of stabilising a laser comprising:
providing a laser or resonator cavity with one or more etalons located within the laser or resonator cavity;
detecting at least a portion of a first beam reflected from the one or more etalons and outputting a first signal;
detecting at least a portion of a second beam transmitted by the one or more etalons and outputting a second signal;
determining a difference between the first and second signals;
translating, varying or altering the optical length of the laser or resonator cavity in response to a control signal based upon the difference between the first and second signals.

According to the preferred embodiment of the present invention it is desired to stabilize the pulse energy of the laser and preferably to keep the laser operating in a single longitudinal mode (SLM).

The preferred embodiment relates to a method of stabilising a laser cavity wherein advantageously an error signal is generated without requiring modulation of any device or parameter. Furthermore, advantageously an internal device or external cell is not required. According to the preferred embodiment the polarization and phase of a beam rejected by a polarizer inside the laser cavity is used to stabilise the laser.

### BRIEF DESCRIPTION OF THE DRAWINGS

Various embodiments of the present invention will now be described, by way of example only, and with reference to the accompanying drawings in which:

FIG. 1A shows how the pulse energy of a laser may vary as a function of the relative frequency of the laser radiation relative to the resonance frequency of the etalon and FIG. 1B shows how the etalon transmission varies as a function of the relative frequency;

FIG. 2A shows the transmission of an etalon for different frequencies of longitudinal modes when a laser is operating in SLM and FIG. 2B shows the transmission of the etalon for two different frequencies when the laser is simultaneously operating in two different longitudinal modes;

FIG. 3A shows a first embodiment of the present invention and FIG. 3B shows second related embodiment of the present invention; and

FIG. 4A shows a first polarization scheme at the side-output of the polarizer and the polarizarion right after the polarizer and FIG. 4B shows the polarization after a quarter-wave plate.

### DESCRIPTION OF THE PREFERRED EMBODIMENTS

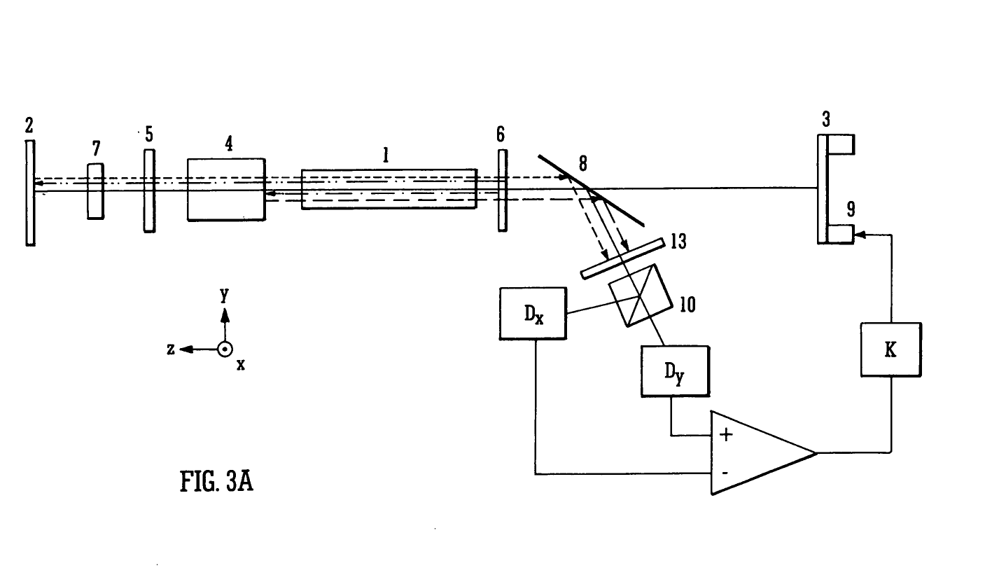

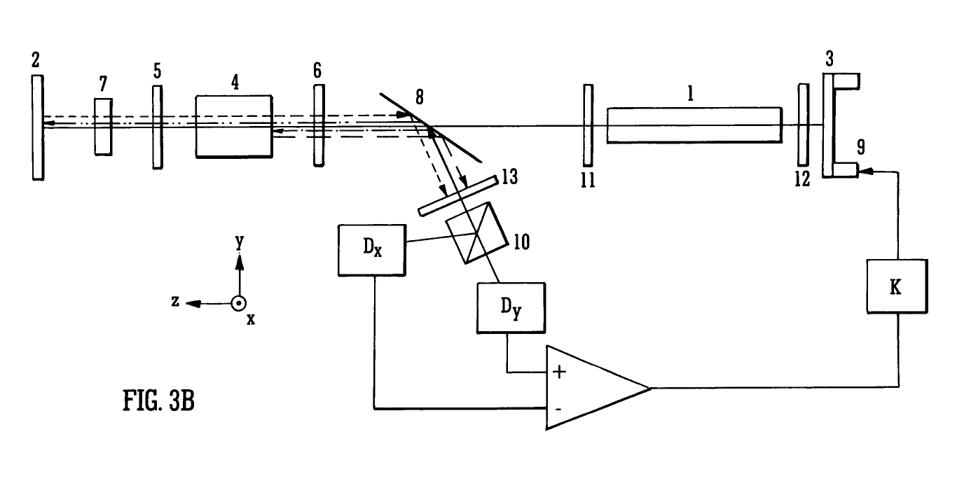

A first embodiment of the present invention is shown in FIG. 3A. In the first embodiment a laser or resonator cavity is provided comprising an active or laser rod 1 or other laser medium, an output coupler 2 and a rear mirror 3. An etalon 4 is preferably provided between the active rod 1 and the output coupler 2 although according to other embodiments the etalon may be located in a different position within the laser or resonator cavity. The etalon 4 is preferably provided adjacent the active rod 1.

A first quarter-wave plate 5 is preferably provided between the etalon 4 and the output coupler 2. The first quarter-wave plate is preferably provided adjacent the etalon 4. A Q-switch 7 or other similar device is preferably provided between the output coupler 2 and the first quarter-wave plate 5. However, according to other embodiments the Q-switch 7 or other similar device may be located in a different position within the laser or resonator cavity.

A second quarter-wave plate 6 is preferably provided between the active rod 1 and the rear mirror 3. A polariser 8 is preferably provided adjacent the second quarter-wave plate 6 and between the second quarter-wave plate 6 and the rear mirror 3. The rear mirror 3 is preferably translatable or otherwise movable so as to vary the optical length of the laser or resonator cavity. One or more piezo-electric devices or piezo-ceramic devices or transducers 9 is preferably coupled to the rear mirror 3 in order to vary the optical length of the laser or resonator cavity. According to an alternative or additional embodiment, the output coupler 2 may additionally or alternatively be translatable by one or more piezo-electric devices or piezo-ceramic devices or transducers (not shown).

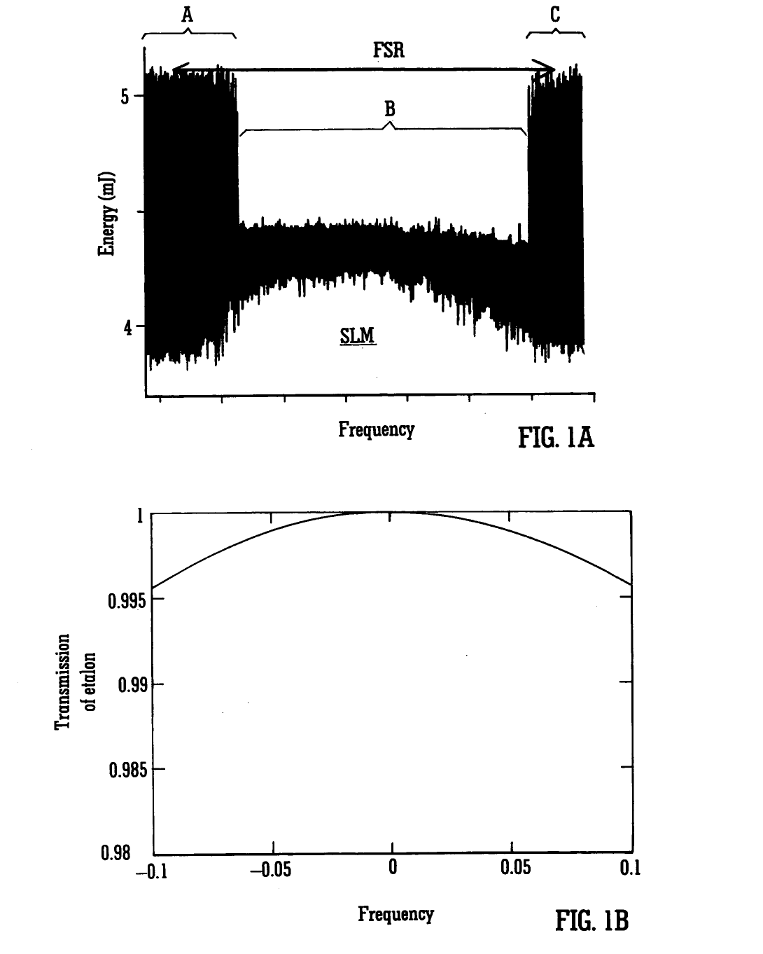

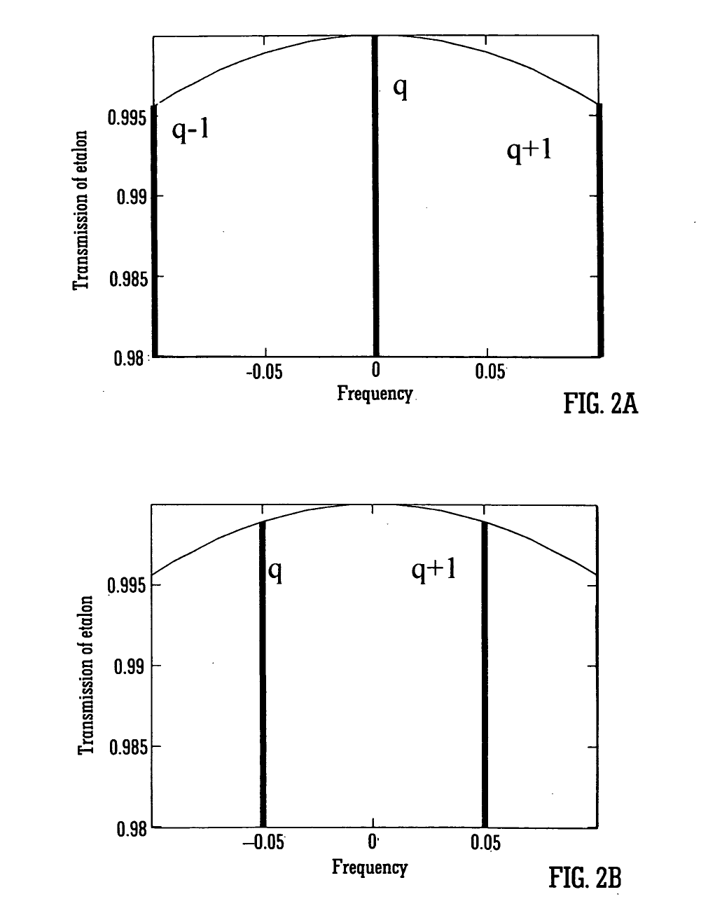

The intra-cavity etalon 4 is preferably used to select or encourage the laser to operate in a single longitudinal mode. Accordingly, a change in the pulse energy will be observed as and when the laser becomes detuned with respect to the resonance frequency of the intra-cavity etalon 4. This is illustrated in FIG. 1A. In the central region B of the graph shown in FIG. 1A the laser is at resonance in a SLM mode of operation and the pulse energy is maximal. As the laser undergoes a drift of its operating mode with respect to the resonance frequency of the etalon 4, the pulse energy will become reduced. If the laser drifts sufficiently or substantially far from resonance of the etalon 4 then the laser will then switch from operating in a single longitudinal mode and will instead operate in a dual mode of operation wherein two longitudinal modes will begin to oscillate simultaneously. The dual longitudinal mode of operation is shown in regions A and C of FIG. 1A.

FIG. 1B shows the transmission of an intra-cavity etalon 4 as a function of frequency relative to the resonance frequency of the etalon 4. In FIGS. 1A and 1B the pulse energy and the etalon transmission are shown over one full Free Spectral Range (FSR). As will be appreciated by those skilled in the art, the pulse energy as shown in FIG. 1A will be periodical in FSR i.e. it will reproduce itself with a period FSR.

In order to correct for any drift of the laser a feedback signal is preferably provided wherein a error signal is preferably generated. According to the preferred embodiment the optical length of the laser cavity is not modulated but rather is varied by mounting either the rear mirror and/or the output coupler of the laser or resonator cavity to a piezo-electric transducer or other device 9. The optical length of the laser or resonator cavity is then varied by applying a voltage to the piezo-electric transducer or other device 9.

A related second embodiment of the present invention is shown in FIG. 3B. The second embodiment differs from the first embodiment shown in FIG. 3A simply in that the active rod 1 is preferably located on the otherside of the polariser 8 with respect to the etalon 4 and/or output coupler 2 whereas according to the first embodiment the active rod 1 is preferably located on the same side of the polariser as the etalon 4 and/or output coupler 2. Two additional quarter-wave plates 11,12 may also preferably be provided, one either side of the active rod 1. The two additional quarter-wave plates are preferably provided adjacent the active rod 1. The laser according to the second embodiment as shown in FIG. 3B is particularly advantageous in that the useful signal or the beams which exit the laser or resonator cavity to provide a difference signal are more clearly separated from the active rod 1 which can be considered as being a relative noise generator.

According to both the first and second embodiments a detection scheme is provided which preferably detects the phase-shift between a beam reflected from the etalon 4 and a beam transmitted by the etalon 4. The detection scheme will now be described in more detail.

According to both embodiments a quarter-wave plate 13 with axes at 45° is preferably provided downstream of polariser 8 and preferably outside of the laser or resonator cavity. A polarisation beamsplitter 10 is preferably provided downstream of the quarter-wave plate 13 and is preferably also located outside of the laser or resonator cavity. The polarisation beamsplitter 10 is preferably oriented with its axis along the vertical or horizontal direction. The outputs (transmitted and reflected) from the polarisation beamsplitter 10 are preferably detected by two detectors Dₓ, D_{y} The two detectors Dₓ, D_{y} are preferably arranged to provide outputs which are proportional to the intensity of the beam detected by the respective detector. A difference between these two signals is then preferably determined, preferably by means of an operational amplifier to provide a difference signal. The difference signal is then preferably amplified and is preferably fed back into or to one or more of the piezo-electric transducers, piezo-ceramic transducers or other devices 9 which are preferably attached to either the rear mirror 3 and/or to the output coupler 2. The feedback signal is preferably fed back to the piezo-electric transducer 9 through or via a gain-filter transfer function.

When the etalon 4 is not at resonance then the beam reflected beam from the etalon 4 will preferably be phase-shifted relative to the beam incident upon the etalon 4.

Since the sign of the phase-shift will depend upon the sign of the detuning (i.e. the laser frequency with respect to the resonance frequency of the etalon 4) an error signal can preferably be obtained.

The first and second quarter-wave plates 5,6 are preferably provided to reduce spatial hole burning in the active rod 1 and to promote competition between adjacent longitudinal modes and hence to promote SLM operation. At least a portion of the beam reflected by the etalon 4 is preferably rejected, or ejected or reflected by the polarizer 8 out of the laser or resonator cavity. This also preferably reduces the risk of damaging other optics.

This arrangement also preferably substantially prevents the laser from possible spurious oscillation between the etalon 4 and the rear mirror 3.

The polarizer 8 preferably rejects a small part or portion of the beam transmitted by the etalon 4. This may be due to the fact that either the polarizer 8 it is not perfect or because the polarizer is deliberately arranged to be slightly less than perfect. In any event, the polarizer 8 is preferably arranged so as to reject two perpendicularly polarized beams from the laser or resonator cavity. The two perpendicularly polarized beams will have a phase shift p between them. In the case where their amplitudes are equal then an elliptically polarized beam is preferably obtained with its great axis at 450 to the transverse laser axes. The sign of its ellipticity will preferably depend directly upon the sign of the laser detuning 6 with respect to the resonance frequency of the etalon 4.

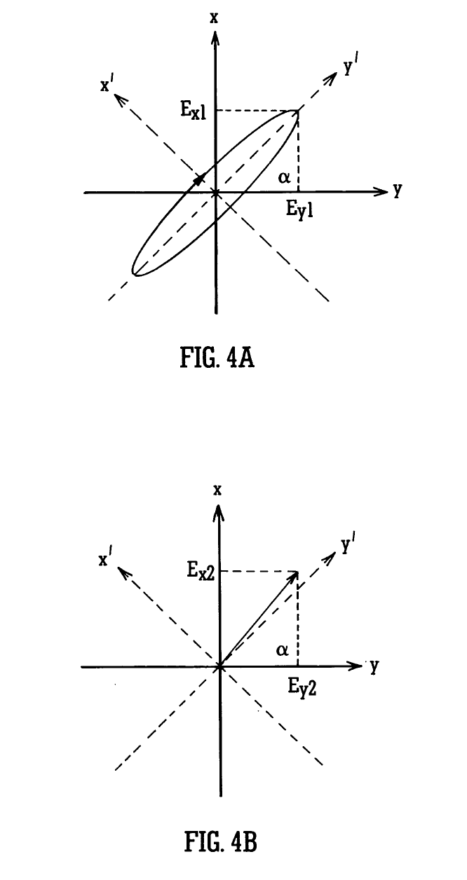

According to the preferred embodiment a quarter-wave plate 13 is provided downstream of the polarizer 8 and outside of the laser or resonator cavity. The axes of the quarter-wave plate 13 are preferably oriented parallel to the polarization ellipse i.e. at 450 to the transverse laser axes. FIGS. 4A and 4B and the following calculations shows how an error signal according to the preferred embodiment can then preferably be obtained.

The polarization ellipse is preferably transformed into a linearly polarized beam with its orientation angle a directly related to the ellipticity and hence also to the laser detuning 6 with respect to the resonance frequency of the etalon 4. Consequently, the difference of intensities along the x and y directions is directly related to the laser detuning.

The result of passing this beam through the polarization beamsplitter 10 arranged downstream of the quarter-wave plate 13 is that two slightly different intensity beams for polarization X and Y will be provided. These beams are then incident upon separate detectors Dₓ, D_{y}. An electronic circuit (analog or digital) e.g. an operational amplifier is preferably arranged to calculate or otherwise determine the difference between the two intensities. The circuit is therefore preferably arranged to provide or otherwise output an error signal which is related to the laser detuning with respect to the resonance frequency of the etalon 4.

The following calculations illustrate the usefulness of the error signal according to the preferred embodiment resulting from the detuning of the laser with respect to the resonance frequency of the etalon 4.

Considering the electric field

$$\vec{{E}_{1}} = [ \begin{matrix}{E}_{x1} \\ {E}_{y1}\end{matrix} ]$$

of the beam rejected or reflected out of the laser or resonator cavity by the polarizer 8:

$$\vec{{E}_{1}} = [ \begin{matrix}{A}_{x} {ⅇ}^{j {φ}_{x}} \\ {A}_{y} {ⅇ}^{j {φ}_{y}}\end{matrix} ] \qquad ( 1 )$$

wherein Aₓ, A_{y}, φₓ, φ_{y} are the amplitude and phase of electric field in x and y directions. The Jones matrix of the downstream quarter-wave plate 13 in (x′,y′) basis can be written:

$$M = [ \begin{matrix}1 & 0 \\ 0 & j\end{matrix} ] \qquad ( 2 )$$

In (x,y) basis it is written:

$$M = [ \begin{matrix}cos α & sin α \\ - sin α & cos α\end{matrix} ] [ \begin{matrix}1 & 0 \\ 0 & j\end{matrix} ] [ \begin{matrix}cos α & - sin α \\ sin α & cos α\end{matrix} ] . \qquad ( 3 )$$

After calculating:

$$M = \frac{1}{2} [ \begin{matrix}1 + j + cos 2 α ( 1 - j ) & - sin 2 α ( 1 - j ) \\ - sin 2 α ( 1 - j ) & 1 + j - cos 2 α ( 1 - j )\end{matrix} ] \qquad ( 4 )$$

After the quarter-wave plate 13 the electric field becomes

$$\vec{{E}_{2}} = [ \begin{matrix}{E}_{x2} \\ {E}_{y2}\end{matrix} ] ,$$

where:

$$\begin{matrix}{E}_{x2} = \frac{1}{2} \{ [ 1 + j + cos 2 α ( 1 - j ) ] {A}_{x} {ⅇ}^{j {φ}_{x}} - sin 2 α ( 1 - j ) {A}_{y} {ⅇ}^{j {φ}_{y}} \} & ( 5 a ) \\ {E}_{y2} = \frac{1}{2} \{ - sin 2 α ( 1 - j ) {A}_{x} {ⅇ}^{j {φ}_{x}} + [ 1 + j - cos 2 α ( 1 - j ) ] {A}_{y} {ⅇ}^{j {φ}_{y}} \} & ( 5 b )\end{matrix}$$

The intensities of each polarization can then be calculated:

$$\begin{matrix}{I}_{x2} = \frac{1}{4} \{ 2 {A}_{x}^{2} [ 1 + {cos}^{2} 2 α ] + 2 {sin}^{2} 2 α \cdot {A}_{y}^{2} \} - \frac{1}{4} sin 2 α {A}_{x} {A}_{y} & ( 6 a ) \\ \{ ( 1 - j ) [ 1 - j + cos 2 α ( 1 + j ) ] {ⅇ}^{j ( {φ}_{x} - {φ}_{y} )} + ( 1 + j ) & \\ [ 1 + j + cos 2 α ( 1 - j ) ] {ⅇ}^{- j ( {φ}_{x} - {φ}_{y} )} \} & \\ {I}_{y2} = \frac{1}{4} \{ 2 {A}_{y}^{2} [ 1 + {cos}^{2} 2 α ] + 2 {sin}^{2} 2 α \cdot {A}_{x}^{2} \} - \frac{1}{4} sin 2 α {A}_{x} {A}_{y} & ( 6 b ) \\ \{ ( 1 + j ) [ 1 + j - cos 2 α ( 1 - j ) ] {ⅇ}^{j ( {φ}_{x} - {φ}_{y} )} + ( 1 - j ) & \\ [ 1 - j - cos 2 α ( 1 + j ) ] {ⅇ}^{- j ( {φ}_{x} - {φ}_{y} )} \} & \end{matrix}$$

After further calculation the following is obtained:

$${I}_{x2} - {I}_{y2} = \frac{1}{2} ( 1 + cos 4 α ) ( {A}_{x}^{2} - {A}_{y}^{2} ) - sin 2 α {A}_{x} {A}_{y} [ sin ( {φ}_{y} - {φ}_{x} ) + cos 2 α cos ( {φ}_{y} - {φ}_{x} ) ] \qquad ( 7 )$$

In the particular case when Aₓ=A_{y} and

$$α = \frac{π}{4} ,$$

then equation (7) reduces to:

$${I}_{x2} - {I}_{y2} = - {A}_{x} {A}_{y} sin ( {φ}_{y} - {φ}_{x} ) . \qquad ( 8 )$$

Thus it is necessary to determine Aₓ and A_{y}. It can be shown that:

$$\begin{matrix}{A}_{x} {ⅇ}^{{jφ}_{x}} = \frac{1 - {ⅇ}^{jσ}}{1 - {Rⅇ}^{jσ}} \sqrt{R} \sqrt{{R}_{p}} & ( 9 a ) \\ {A}_{y} {ⅇ}^{{jφ}_{y}} = {( \frac{T}{1 - {Rⅇ}^{jσ}} )}^{2} {T}_{QS} \sqrt{{R}_{OC}} \sqrt{{R}_{s}} {ⅇ}^{jϕ} & ( 9 b )\end{matrix}$$

wherein σ is the phase-shift (modulo 2π) of light over one round trip inside the etalon 4 and φ is the phase-shift between both polarizations due to the geometry of the resonator. This phase-shift can be adjusted by tilting the Q-switch 7 for example.

In the following it is considered that the etalon 4 is close to resonance due to the feedback loop being locked.

Introducing the limited expansions at first order:

$$\begin{matrix}{A}_{x} {ⅇ}^{{jφ}_{x}} = \frac{- j σ}{1 - R ( 1 + j σ )} \sqrt{R} \sqrt{{R}_{p}} & ( 10 a ) \\ {A}_{y} {ⅇ}^{{jφ}_{y}} = {( \frac{T}{1 - R ( 1 + j σ )} )}^{2} {T}_{QS} \sqrt{{R}_{OC}} \sqrt{{R}_{s}} {ⅇ}^{jϕ} & ( 10 b )\end{matrix}$$

After simplifying:

$$\begin{matrix}{A}_{x} = \frac{\sqrt{R . {R}_{p}}}{1 - R} σ & ( 11 a ) \\ {φ}_{x} = - \frac{π}{2} & ( 11 b ) \\ {A}_{y} = {T}_{QS} \sqrt{{R}_{OC}} \sqrt{{R}_{s}} & ( 11 c ) \\ {φ}_{y} = φ + Arctan ( \frac{2 R}{1 - R} σ ) & ( 11 d )\end{matrix}$$

It is then necessary to expand the term sin(φ_{y}−φₓ) in Eq. (8):

$$\begin{matrix}sin ( {φ}_{y} - {φ}_{x} ) = sin ( ϕ + Arctan ( \frac{2 R}{1 - R} σ ) + \frac{π}{2} ) & ( 12 ) \\ sin ( {φ}_{y} - {φ}_{x} ) = \begin{matrix}cos ϕ cos [ Arctan ( \frac{2 R}{1 - R} σ ) ] - \\ sin ϕsin [ Arctan ( \frac{2 R}{1 - R} σ ) ]\end{matrix} & ( 13 ) \\ sin ( {φ}_{y} - {ϕ}_{x} ) = \frac{cos ϕ}{\sqrt{1 + {( \frac{2 R}{1 - R} )}^{2} {σ}^{2}}} - sin ϕ \frac{\frac{2 R}{1 - R} σ}{\sqrt{1 + {( \frac{2 R}{1 - R} )}^{2} {σ}^{2}}} & ( 14 )\end{matrix}$$

Finally:

$$sin ( {φ}_{y} - {φ}_{x} ) = cos ϕ - sin ϕ \frac{2 R}{1 - R} σ \qquad ( 15 )$$

Introducing Eqs. (11a), (11c), and (15) into Eq. (8) yields:

$${I}_{x2} - {I}_{y2} = - \frac{\sqrt{R . {R}_{p} . {R}_{OC} . {R}_{S}}}{1 - R} {T}_{QS} ( cos ϕ - sin ϕ \frac{2 R}{1 - R} σ ) σ \qquad ( 16 )$$

A first-order expression is preferably required in order to have a more useable error signal. It is therefore necessary to adjust φ to 0, so that:

$${I}_{x2} - {I}_{y2} = - \frac{\sqrt{R . {R}_{p} . {R}_{OC} . {R}_{S}}}{1 - R} {T}_{QS} . σ \qquad ( 17 )$$

In a Fabry-Perot interferometer the relationship between the phase-shift a over one round-trip and the detuning σ of light with respect to the resonance frequency of the etalon is:

$$δ = Δ \frac{σ}{2 π} \qquad ( 18 )$$

wherein Δ is the Free Spectral Range (FSR) of the etalon.

Accordingly, Eq. (17) reduces to:

$${I}_{x2} - {I}_{y2} = - \frac{2 π}{Δ} \frac{\sqrt{R . {R}_{p} . {R}_{OC} . {R}_{S}}}{1 - R} {T}_{QS} . δ \qquad ( 19 )$$

The difference in intensities can be detected and determined electronically. The resulting difference signal can then preferably be fed back to the one or more piezo-electric transducers (PZT) 9 or other devices which are preferably used to vary the optical length of the laser or resonator cavity preferably through or via an adjustable gain.

The difference signal as presented by Eq. (19) will preferably be relatively small. The ratio ρ of the signal can be calculated with respect to the total energy reflected by the polarizer 8:

$$ρ = \frac{{I}_{x2} - {I}_{y2}}{{I}_{x2} + {I}_{y2}} \qquad ( 20 )$$

After the approximation that the detuning is relatively small the following is obtained:

$$ρ = \frac{2 π}{Δ \cdot {T}_{QS} \cdot ( 1 - R )} \cdot \sqrt{\frac{R \cdot {R}_{p}}{{R}_{OC} \cdot {R}_{S}}} \cdot δ \qquad ( 21 )$$

By way of example, if T_{QS}˜1, R=0.5, R_{OC}=0.21, Rₚ/R_{S}=0.02, Δ=4 GHz and σ=10 MHz (sensitivity required on the detuning) then a value of ρ=0.007 is obtained. The energy reflected by the polarizer 8 can be observed and so a difference signal can also practically be determined.

Further embodiments are contemplated wherein the noise in the system is taken into consideration. The degree of polarization at the laser output may be considered to be approximately 1%. It can therefore be assumed that it is about the same inside the cavity. Since Rₚ=0.02 then noise may account for approximately half of it. It is assumed that any noise will be due to spontaneous emission. Low-pass filtering can therefore be incorporated into the transfer function in order to reduce substantially the noise component.

According to the preferred embodiment pulses received on or detected by semiconductor detectors Dₓ,D_{y} may preferably be converted from light into electrical current or signal. The current or signal can then preferably be integrated and a voltage proportional to the pulse energy can preferably be latched until the next pulse. The voltages from detectors Dₓ,D_{y} are preferably fed into an op-amp or other device to produce a difference voltage or signal. The output from the op-amp is then preferably fed into another op-amp which is preferably arranged to act as a low-pass filter with adjustable gain. An appropriate gain can preferably be selected or determined once the input signals are of sufficiently high quality.

It is also contemplated that the frequency of other forms or types of laser arrangements or similar devices can be stabilized relative to an etalon forming part of the laser system by using the stabilization method according to the preferred embodiment as described above.

The laser according to the preferred embodiment is preferably pulsed but according to other less preferred embodiments the laser may be operated in a continuous wave (CW) mode of operation.

According to the preferred embodiment the laser is preferably a solid-state laser but according to other less preferred embodiment other forms or types of laser such as gas lasers may be stabilised using the preferred stabilisation method.

Whilst the preferred embodiment relates to varying the length of the optical cavity a less preferred embodiment is contemplated wherein the temperature of the laser cooling water is varied. It is also contemplated that the temperature of the etalon or any other optical device or optical component within the laser or resonator cavity may be varied in an analogous manner to the manner described above in relation to the preferred embodiment.

Finally, it is also contemplated that alternative methods or means of varying the laser or resonator cavity may be used. For example, a photorefractive material, electro-optic or other material whose refractive index may be varied, modulated or externally changed may be used to vary and/or modulate the optical length of the laser or resonator cavity. This will vary the eigen frequency of the mode and can be used for modulation.

Although the present invention has been described with reference to preferred embodiments it will be understood by those skilled in the art that various changes in form and detail may be made without departing from the scope of the invention as set forth in the accompanying claims.

1. A laser comprising:
a laser or resonator cavity;
one or more etalons located within said laser or resonator cavity;
a first detector for detecting at least a portion of a first beam reflected from said one or more etalons, said first detector outputting a first signal;
a second detector for detecting at least a portion of a second beam transmitted by said one or more etalons, said second detector outputting a second signal;
means for determining a difference between said first and second signals; and
one or more devices for translating, varying or altering the optical length of said laser or resonator cavity in response to a control signal based upon the difference between said first and second signals.

2. A laser as claimed in claim 1, further comprising a polarisation beam splitter for separating at least a portion of said first beam from at least a portion of said second beam.

3. A laser as claimed in claim 2, wherein said polarisation beam splitter is arranged outside of said laser or resonator cavity.

4. A laser as claimed in claim 1, further comprising a polariser arranged within said laser or resonator cavity.

5. A laser as claimed in claim 4, wherein at least a portion of said first beam and/or at least a portion of said second beam is directed or reflected out of said laser or resonator cavity by said polariser.

6. A laser as claimed in claim 4, further comprising a quarter-wave plate arranged outside of said laser or resonator cavity and arranged between said polariser and a polarisation beam splitter.

7. A laser as claimed in claim 1, further comprising a quarter-wave plate arranged within said laser or resonator cavity and arranged between said one or more etalons and a polariser.

8. A laser as claimed in claim 1, wherein said one or more etalons are arranged to select or encourage said laser to operate in a single longitudinal mode.

9. A laser as claimed in claim 1, wherein said laser or resonator cavity comprises a linear laser or resonator cavity.

10. A laser as claimed in claim 1, wherein said laser or resonator cavity comprises a ring laser or resonator cavity.

11. A laser as claimed in claim 1, wherein said laser comprises at least one output coupler.

12. A laser as claimed in claim 11, wherein at least one of said devices for translating, varying or altering the optical length of said laser or resonator cavity is arranged to translate, vary or alter said at least one output coupler.

13. A laser as claimed in claim 11, further comprising a quarter-wave plate arranged between said one or more etalons and said at least one output coupler.

14. A laser as claimed in claim 1, wherein said laser comprises at least one rear mirror.

15. A laser as claimed in claim 14, wherein at least one of said devices for translating, varying or altering the optical length of said laser or resonator cavity is arranged to translate, vary or alter said at least one rear mirror.

16. A laser as claimed in claim 14, further comprising a quarter-wave plate arranged between said one or more etalons and said at least one rear mirror.

17. A laser as claimed in claim 1, wherein said one or more devices for translating, varying or altering the optical length of said laser or resonator cavity comprises one or more piezo-electric transducers or devices or one or more piezo-ceramic transducers or devices.

18. A laser as claimed in claim 1, wherein said means for determining a difference comprises an operational amplifier.

19. A laser as claimed in claim 1, further comprising a low-pass filter for low-pass filtering a difference signal or averaging means for averaging a difference signal, said difference signal being based upon the difference between said first and second signals.

20. A laser as claimed in claim 19, wherein said difference signal after being low-pass filtered or averaged is arranged to be applied or supplied, in use, to said one or more devices in order to translate, vary or alter the optical length of said laser or resonator cavity.

21. A laser as claimed in claim 1, wherein said laser comprises one or more active or laser rods or active media arranged within said laser or resonator cavity.

22. A laser as claimed in claim 21, wherein said one or more active or laser rods or active media are arranged on the same side of a polariser as said one or more etalons.

23. A laser as claimed in claim 21, wherein said one or more active or laser rods or active media are arranged on the opposite side of a polariser as said one or more etalons.

24. A laser as claimed in claim 23, further comprising a first additional quarter-wave plate between said polariser and said one or more active or laser rods or active media.

25. A laser as claimed in claim 23, further comprising a second additional quarter-wave plate between said one or more active or laser rods or active media and an output coupler or rear mirror.

26. A laser as claimed in claim 1, further comprising a Q-switch arranged within said laser or resonator cavity.

27. A laser as claimed in claim 1, wherein said laser comprises a pulsed laser.

28. A laser as claimed in claim 1, wherein said laser comprises a continuous wave laser.

29. A laser as claimed in claim 1, wherein said laser comprises a solid-state laser.

30. A laser as claimed in claim 1, wherein said laser is operated, in use, in a single longitudinal mode.

31. A holographic printer for printing holograms comprising a laser as claimed in claim 1.

32. A holographic printer as claimed in claim 31, wherein said holographic printer comprises a red, green and blue (“RGB”) holographic printer.

33. A holographic printer as claimed in claim 31, wherein said holographic printer comprises a Master Write or Direct Write holographic printer.

34. A method of stabilising a laser comprising:
providing a laser or resonator cavity with one or more etalons located within said laser or resonator cavity;
detecting at least a portion of a first beam reflected from said one or more etalons and outputting a first signal;
detecting at least a portion of a second beam transmitted by said one or more etalons and outputting a second signal;
determining a difference between said first and second signals;
translating, varying or altering the optical length of said laser or resonator cavity in response to a control signal based upon the difference between said first and second signals.
